(19) United States
(12) Patent Application Publication
(10) Pub. No.: US 2018/0046391 A1
(43) Pub. Date: Feb. 15, 2018

(54) Systems and Methods for Hosting Web Applications Within Remote Management Hardware and/or Firmware

(71) Applicant: Intel Corporation, Santa Clara, CA (US)

(72) Inventors: YLIAN SAINT-HILAIRE, Hillsboro, OR (US); TSIPPY MENDELSON, Modiin (IL)

(21) Appl. No.: 15/231,784

(22) Filed: Aug. 9, 2016

(51) Int. Cl. G06F 3/06; G06F 1/32; G06F 17/30

(52) U.S. Cl. CPC G06F 3/0625; G06F 17/30887; G06F 3/0679; G06F 1/3287; G06F 3/0655

(57) ABSTRACT

A system and method are disclosed for remote management, including systems and methods for hosting web applications within remote management hardware and/or firmware. In one embodiment, a system includes a microcontroller to configure a processor, the microcontroller including a memory. The system further includes a network interface coupled to the microcontroller, the network interface to send and receive communications with an external device. The system further includes a non-volatile memory to store computer executable instructions to be executed by the microcontroller, and a power supply to provide power to the microcontroller, the network interface, and the non-volatile memory regardless of the power state of the processor, wherein the microcontroller is to provide a web server to receive and process HyperterText Transfer Protocol (HTTP) requests from the external device.

### TECHNICAL FIELD

Embodiments described herein generally relate to remote management of computers. In particular, embodiments described generally relate to systems and methods for hosting web applications within remote management hardware and/or firmware.

### BACKGROUND

Remote management of computers may be enabled by hardware and/or firmware included in them. Remote management would allow for computers, including large groups of computers, to be updated, reconfigured, internationalized, and branded. However, remote management systems may be more likely to be used if they are relatively easy to use and setup, yet include beneficial tools, and do not require complicated third party software to be installed.

### BRIEF DESCRIPTION OF THE DRAWINGS

The various advantages of the embodiments disclosed herein will become apparent to one skilled in the art by reading the following specification and appended claims, and by referencing the drawings, in which:

FIG. 1 is a block diagram illustrating an embodiment of an out-of-band remote management hardware and/or firmware system;

FIG. 2 is a block diagram illustrating another embodiment of a remote out-of-band management platform using remote management hardware and/or firmware;

FIG. 3 is a block flow diagram illustrating a process to load remote management hardware and/or firmware with configuration data to be used in subsequently served web pages;

FIG. 4 is a flow diagram illustrating an embodiment of a process to use an application hosted within remote management hardware and/or firmware and a web browser to remotely manage a PC;

FIG. 5 is an embodiment of a web page of a remote management application loaded into a web browser from remote management hardware and/or firmware;

FIG. 6 is a block flow diagram illustrating an embodiment of a process to use a web application to establish a two-way connection with remote management hardware and/or firmware;

FIG. 7 is a flow diagram illustrating an embodiment of a process to use a web application to establish a two-way connection with remote management hardware and/or firmware; and

FIG. 8 is an embodiment of a process to remotely manage multiple computers using an application loaded into a web browser from remote management hardware and/or firmware.

### DETAILED DESCRIPTION

In the following description, numerous specific details are set forth. However, it is understood that embodiments of the disclosure may be practiced without these specific details. In other instances, well-known circuits, structures and techniques have not been shown in detail to not obscure the understanding of this description.

References in the specification to “one embodiment,” “an embodiment,” “an example embodiment,” etc., indicate that the embodiment described may include a particular feature, structure, or characteristic, but every embodiment need not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments disclosed relate to remotely managed hardware and software (e.g., processors and computer systems). One challenge posed by a remote management system is the degree of complexity in administering the system. For example, setting up and configuring one or more third party software applications may discourage administrators from using a remote management system. Embodiments disclosed herein allow for remote administration of computer systems using a web browser.

This browser based approach allows for remote connection to and operation of components of a computer system having a processor in a sleep or soft-off state. As used herein, a “soft-off” state is when the user sessions in a computer system are shut down. In some embodiments, during a soft-off, user sessions are torn down and restarted on the next boot. In some embodiments, a soft-off occurs when a system restart is requested.

In some embodiments, a web socket is established between the browser and the remote computer system.

Configuration information is pushed onto the remote computer system without involving the computer system's primary processor (e.g., CPU) or operating system. Embodiments disclosed herein utilize a secondary processor and/or firmware that implements a web server and allows for remote configuration of components of the computer system using a web browser. Embodiments disclosed herein allow for configuration of a single remote computer or multiple computers in a datacenter.

Remote management embodiments disclosed herein include a microcontroller (secondary processor) coupled with and able to configure components of a computer system including, for example, a primary processor. The disclosed microcontroller includes a network interface to allow it to communicate with a remote computer, for example an administrator's computer. It also includes a memory to store executable instructions, and a memory to store content. It is coupled to a power supply to receive power even when the primary processor is asleep or in a soft-off state. In operation, the microcontroller, by executing the executable instructions, implements a process of implementing a web server to receive and process a set of at least two types of HyperterText Transfer Protocol (HTTP) requests from the remote computer, the set of requests to cause the microcontroller to administer the primary processor independently of an operating system associated with the processor, and independently of a power state of the primary processor.

To the extent that the microcontroller operates independently of the processor and the processor's operating system, it is referred to herein as an out-of-band (00B) microcontroller.

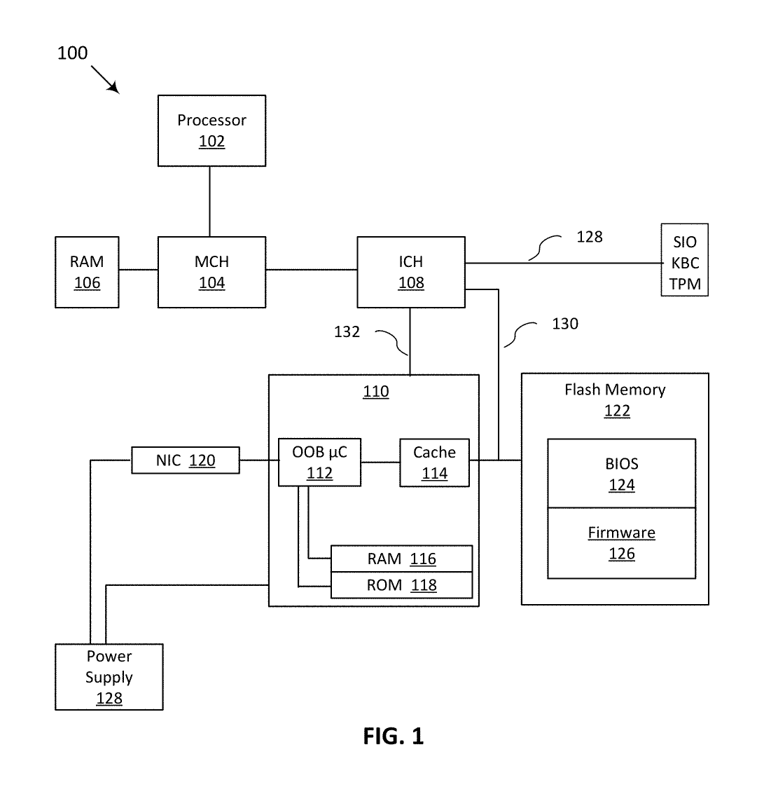

FIG. 1 is a block diagram illustrating an embodiment of a remote out-of-band management platform using remote management hardware and/or firmware system. Embodiments of this platform have a network connection, such as a network interface card (NIC) 120. NIC 120 may be used to communicate with a remote computer, such as a management computer operated by an administrator.

As shown, platform 100 includes a primary processor 102 (e.g., a CPU), which is connected to random access memory 106 via a memory controller hub (MCH) 104. In some embodiments, not shown, some or all portions of the MCH are incorporated into the processor. Processor 102 may be any type of processor capable of executing software, such as a microprocessor, digital signal processor, microcontroller, or the like. In some embodiments, processor 102 is the main (primary) processor used to run an operating system and to control a computer. As illustrated, remote management hardware and/or firmware 110 allows remote management of processor 102 using a web browser. In some embodiments, remote management hardware and/or firmware 110 allows management of other interfaces on the platform. For example, remote management hardware and/or firmware 110 allows configuration of other processors and controllers included in the platform 100 and coupled to remote management hardware and/or firmware 110.

Though FIG. 1 shows only one processor 102, some embodiments include at least one additional processor in the platform 100 and at least one of the processors includes multiple threads, multiple cores, or the like. Some embodiments include many computers, such as all of the computers of a corporate facility or datacenter, in which case each computer includes platform 100, and each computer is managed using a web browser on a remote computer.

As illustrated, processor 102 is further connected to I/O devices via an input/output controller hub (ICH) 108. The ICH may be coupled to various devices, such as a super I/O controller (SIO), keyboard controller (KBC), or trusted platform module (TPM) via a bus 128. In an embodiment, ICH 108 is coupled to non-volatile flash memory 122 via bus 130. In the illustrated embodiment, remote management hardware and/or firmware 110 connects to ICH 108 via bus 132. Remote management hardware and/or firmware 110 is coupled to non-volatile flash memory 122 via bus 130. In some embodiments, processor 102 uses an embedded controller instead of SIO controller.

Remote management hardware and/or firmware 110 may be likened to a “miniature” processor. In some embodiments, like a full capability processor, remote management hardware and/or firmware 110 includes microcontroller 112 which is coupled to a cache memory 114, random access memory (RAM) 116, read-only memory (ROM) 118, and flash memory 122. Cache memory 114 and RAM 116 are volatile memories used by microcontroller 112 to store temporary data at run-time.

ROM 118 and flash memory 122, on the other hand, are non-volatile memories, which in some embodiments are loaded with computer-executable instructions to be executed by microcontroller 112. When remote management hardware and/or firmware 110 operates out-of-band, it does not have access to the computer's operating system, its processor, or its system storage. At least some of the instructions it is to execute, in other words its firmware, are thus to be stored in ROM 118 and/or flash memory 122. In some embodiments, microcontroller 112's firmware is stored in ROM 118. In some embodiments, ROM 118 stores micro-instructions that make up microcontroller 112's instruction set architecture. In alternate embodiments, microcontroller 112's firmware is to be stored in a portion of flash memory 122 labeled as firmware 126. Flash memory 122 also stores a Built-In Operating System (BIOS) 124 for use by microcontroller 112.

In some embodiments, firmware 126 and the BIOS 124 are reprogrammed as needed and with little difficulty. In alternate embodiments, the BIOS and firmware within flash memory 122 are updated when needed. In some embodiments, an administrator operating a web browser on a remote computer reprograms firmware 126 securely using a Transport Layer Security (TLS) protocol or Secure Socket Layer (SSL) protocol.

The storage space afforded by flash memory 122 is not unlimited. The memory size of the firmware 126 and the BIOS 124 is small enough to fit on the flash memory 122. In an exemplary embodiment, flash memory 122 includes 8 Megabits of storage, and the size of the code to implement a web server is less than 60 Kbytes.

OOB μController 112 includes a network interface, which in some embodiments is a network interface 120. OOB μController 112 is further connected to a power supply 128, which provides power to allow out-of-band communication even when the in-band processor 102 is not active, or fully booted.

In some embodiments, OOB μController 112 uses a basic input output system (BIOS) 124 stored in non-volatile memory 122. In other embodiments, OOB μController 112 boots using instructions stored on and received from a different device (not shown). Remote management hardware and/or firmware 110 may have access to all of the contents of the non-volatile memory 122, including the BIOS portion 124 and a protected portion 126 of the non-volatile memory. In some embodiments, the protected portion 126 of memory is for use by remote management hardware and/or firmware.

OOB μController 112 in some embodiment uses the protected portion 126 of flash memory 122 to securely store certificates, keys and signatures that are inaccessible by the BIOS, firmware or operating system.

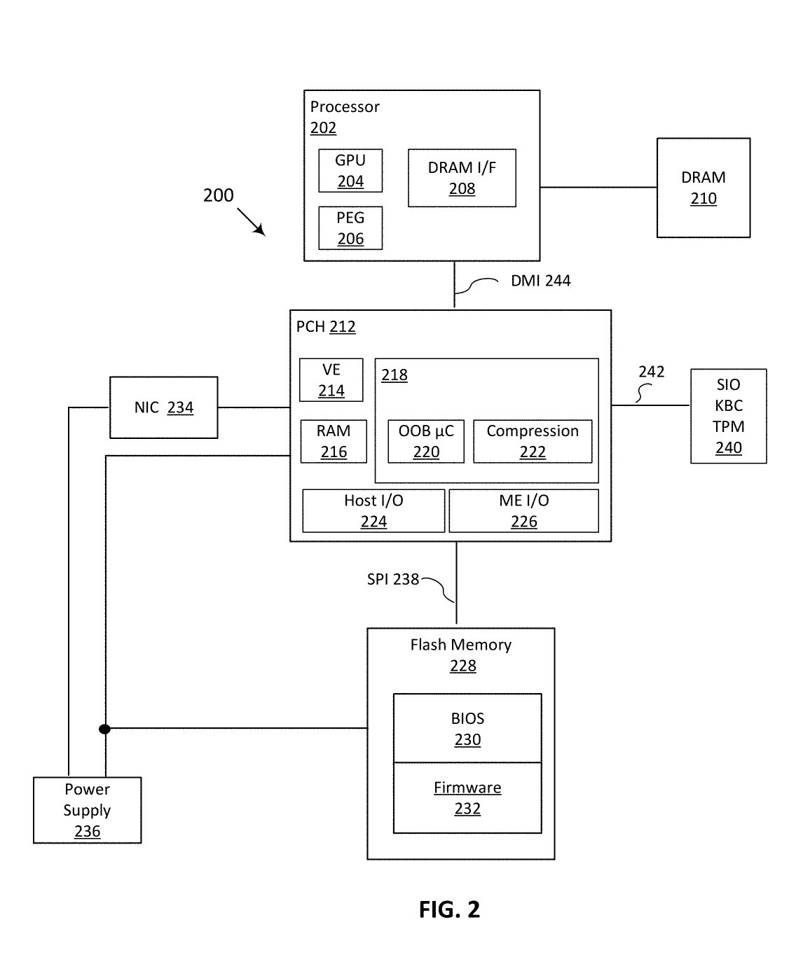

FIG. 2 is a block diagram illustrating another embodiment of a remote out-of-band management platform using remote management hardware and/or firmware. Embodiments of this platform have a network connection, such as a network interface card (NIC) 230. NIC 230 may be used to communicate with a remote computer, such as a management computer operated by an administrator.

As shown, platform 200 includes a primary processor 202 (e.g., a CPU), which is connected to dynamic random access memory (DRAM) 210 via a DRAM interface (DRAM I/F) 208. Processor 202 may be any type of processor capable of executing software, such as a microprocessor, digital signal processor, microcontroller, or the like. In some embodiments, processor 202 is the main (primary) processor used to run an operating system and to control a computer. Processor 202 also includes graphics processing unit (GPU) 204 and peripheral component interface (PCI) express for graphics (PEG) 206.

As shown, processor 202 uses desktop management interface (DMI) 244 to connect to platform controller hub (PCH) 212, which includes virtualization engine (VE) 214, random access memory (RAM) 216, remote management hardware and/or firmware 218, Host input/output (I/O) interface 224, and input/output interface (I/O) 226. In some embodiments, PCH 212 does not include VE 214.

In the illustrated embodiment, remote management hardware and/or firmware 218 further includes OOB μController 220 and compression block 222. Remote management hardware and/or firmware 218 allows remote management of processor 202 using a web browser. In some embodiments, remote management hardware and/or firmware 218 allows management of other devices on the platform. For example, remote management hardware and/or firmware 218 allows configuration of other processors and controllers included in the platform 200 and coupled to remote management hardware and/or firmware 210. For example, remote management hardware and/or firmware 218 allows management and configuration of other processors or controllers included in PCH 212.

Though FIG. 2 shows only one processor 202, some embodiments include at least one additional processor in the platform 200 and at least one of the processors includes multiple threads, multiple cores, or the like. Some embodiments include many computers, such as all of the computers of a corporate facility or datacenter, in which case each computer includes platform 200, and each computer is managed using a web browser on a remote computer.

As illustrated, PCH 212 is connected to I/O device interfaces, including a super I/O controller (SIO), keyboard controller (KBC), or trusted platform module (TPM) via a bus 242. In an embodiment, PCH 212 is coupled to non-volatile flash memory 228 via serial peripheral interface (SPI) bus 238. In the illustrated embodiment, PCH 212 is further coupled to network interface card 234 and power supply 236. In the illustrated embodiment, remote management hardware and/or firmware 218 is incorporated within PCH 212 and therefore also has access to flash memory 228, NIC 234, and power supply 236.

Remote management hardware and/or firmware 218 may be likened to a “miniature” processor, as it includes microcontroller 220, and is coupled to and able to use random access memory (RAM) 216, and flash memory 222. In some embodiments, RAM 216 includes a cache memory.

When remote management hardware and/or firmware 218 operates out-of-band, it does not have access to the computer's operating system, its processor, or its system storage. At least some of the instructions it is to execute, are thus stored in flash memory 228, which receives sufficient power from power supply 236 to operate. In some embodiments, microcontroller 220's firmware is to be stored in a portion of flash memory 228 labeled as firmware 232. Flash memory 228 also stores a Built-In Operating System (BIOS) 230 that in some embodiments is used by microcontroller 220.

In some embodiments, firmware 232 and the BIOS 230 are reprogrammed as needed. In alternate embodiments, the BIOS and firmware within flash memory 228 are updated when needed. In some embodiments, an administrator operating a web browser on a remote computer reprograms firmware 232 securely using a Transport Layer Security (TLS) protocol or Secure Socket Layer (SSL) protocol.

The storage space afforded by flash memory 228 is not unlimited. The memory size of the firmware 232 and the BIOS 230 is small enough to fit on the flash memory 228. In an exemplary embodiment, flash memory 228 includes 8 Megabits of storage, and the size of the code to implement a web server is less than 60 Kbytes. The sizes of flash memory 220 and the web server code size are not limited to 8 Megabits and 60 Kbytes; in some embodiments one or both of them is larger, and in other embodiments one or both of them is smaller.

OOB μController 220, NIC 234, and flash memory 228 are coupled to power supply 236, which in some embodiments provides sufficient power for them to operate out-of-band, when processor 202 is in a sleep or soft-off power state.

In some embodiments, remote management hardware and/or firmware 218 includes a compression block 222, which may use compression algorithms, including any lossy or lossless algorithms, for example. In one embodiment, OOB μController 220 sends the compressed contents to a remote computer via NIC 234.

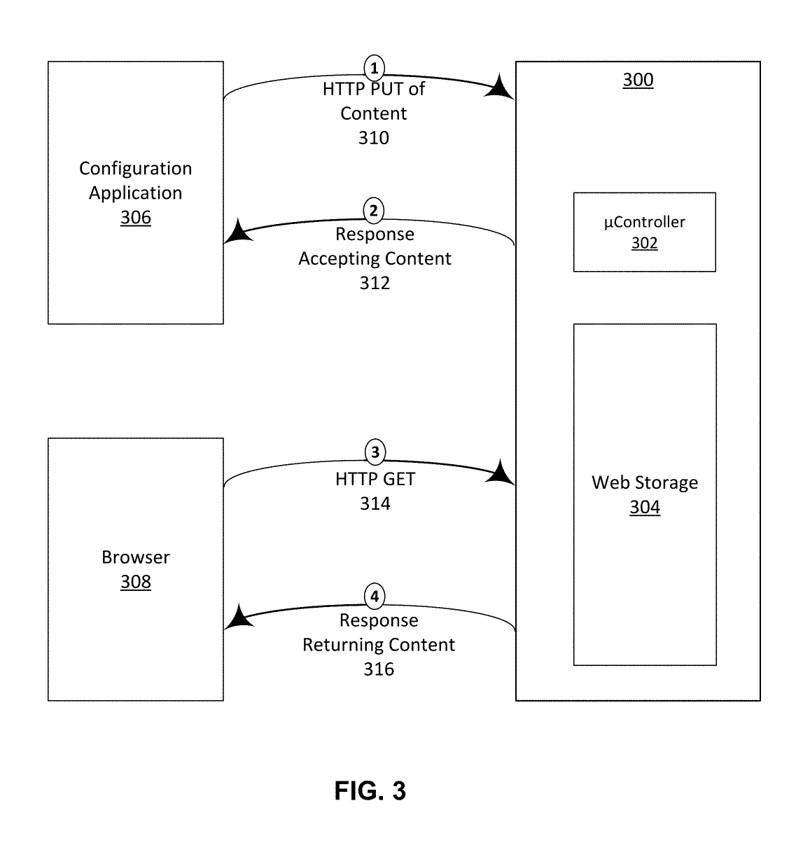

FIG. 3 is a block flow diagram illustrating a process to load remote management hardware and/or firmware with configuration data to be used in subsequently served web pages. As shown, remote management hardware and/or firmware 300 includes a μController 302 and web storage 304. In some embodiments, web storage 304 allows administrators operating a remote computer to push blocks of data along with HTTP headers that are served back by HTTP get request. Web storage 304 acts like a generic web server incorporated within the remote management hardware and/or firmware. In some embodiments, μController 302 is a secondary processor that is included on a PC motherboard and coupled to the processor and other components, for example as shown in FIG. 1. As illustrated, the web storage 304 within remote management hardware and/or firmware 300 receives an HTTP PUT request 310 to push content onto web storage 304, at the path labeled as “1,”. In some embodiments, the HTTP PUT request originates from a configuration application 306 that is running on a remote computer and is coupled to remote management hardware and/or firmware 300 over a network. Remote management hardware and/or firmware 300 responds at 312, at the path labeled as “2,” to acknowledge receipt of the configuration content. Subsequently, remote management hardware and/or firmware 300 receives an HTTP GET request 314 for a web page, at a path labeled as “3.” In some embodiments, the HTTP GET request is issued by a web browser 308 running on a remote computer. In other embodiments, the HTTP GET request is received from the local operating system of the same machine. The remote management hardware and/or firmware sends a response 316, at a path labeled as “4,”, which serves a web page that reflects the requested content. For example, μController 302 in some embodiments dynamically generates the responsive web page, and includes relevant portions of the configuration content. The illustrated process may be repeated without limitation in order to configure an unlimited number of configuration settings.

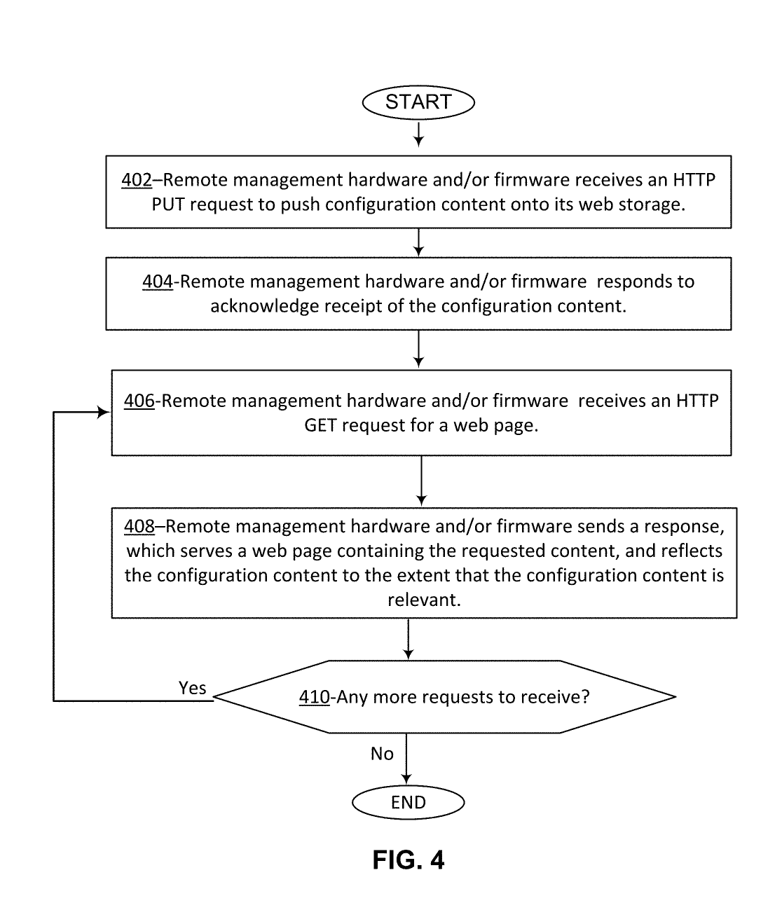

FIG. 4 is a flow diagram illustrating an embodiment of a process to load remote management hardware and/or firmware with configuration content to be included in subsequently served web pages. At 402, remote management hardware and/or firmware receives an HTTP PUT request to push configuration content onto web storage. In some embodiments, the HTTP PUT request originates from a remote administrator's computer, with the administrator using a web browser to conduct management operations. At 404, remote management hardware and/or firmware responds to acknowledge receipt of the configuration content. At 406, remote management hardware and/or firmware receives an HTTP GET request for a web page. At 408, remote management hardware and/or firmware sends a response, which serves a web page containing the requested content, and reflects the configuration content to the extent that the configuration content is relevant. The illustrated process may be repeated without limitation in order to configure an unlimited number of configuration settings.

In some embodiments, at 402, the HTTP PUT request pushes HTTP headers onto the remote management hardware and/or firmware in addition to the content. For example, the HTTP PUT request may include a “content type” header. Or, the HTTP PUT request may include a “content-encoding” header. Accordingly, when remote management hardware and/or firmware serves a responsive web page at 408, it applies the content-type and content-encoding to display the content correctly. At 410, it is determined whether any more requests are to be received. If so, the process returns to 406. In not, the process ends.

Furthermore, in some embodiments, remote management hardware and/or firmware store the HTTP headers pushed into it at 402 in a cache memory, so that the headers are quickly and efficiently accessed when remote management hardware and/or firmware serves up web pages.

In some embodiments, remote management hardware and/or firmware stores predefined web pages in its firmware, such as firmware 126 (FIG. 1). For example, remote management hardware and/or firmware may store a “logon.html” web page. Remote management hardware and/or firmware may store an “index.html” web page. Remote management hardware and/or firmware may further store web pages linked to the web browser being used by an administrator at the remote computer. Having these web pages ready to serve helps provide an “out-of-the-box” experience.

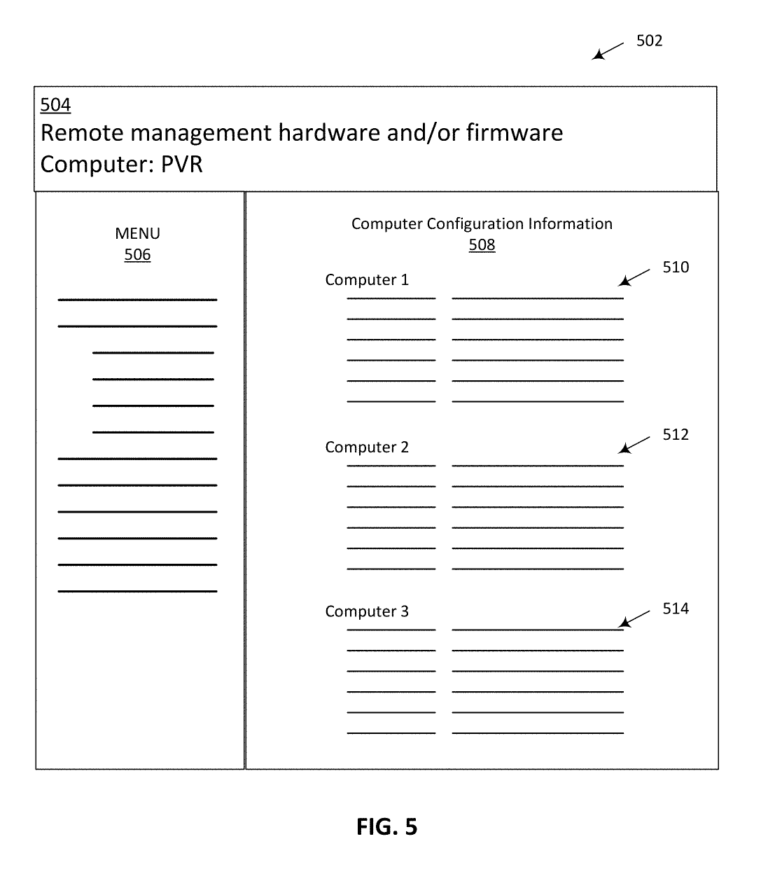

FIG. 5 is an embodiment of a remote management web page displayed on a remote computer and used to administer a computer that incorporates remote management hardware and/or firmware according to embodiments disclosed herein. In some embodiments, web page 502 is generated and served by remote management hardware and/or firmware microcontroller's web server. In some embodiments, web page 502 is a static web page stored in the remote microcontroller's firmware. In alternate embodiments, web page 502 is a static web page stored in firmware. In yet other embodiments, web page 502 is dynamically generated by the microcontroller. As illustrated, web page 502 includes a title bar 504, a menu 506, and computer configuration information 508 for three computers, 510, 512, and 514. In some embodiments, at least part of computer configuration information 510, 512, and 514, consists of configuration data previously pushed into the remote management hardware and/or firmware web storage.

In some embodiments, the web server processes a wide variety of HTTP methods, as defined in various Requests for Comment (RFCs) promulgated by the Internet Engineering Task Force (IETF). For example, the microcontroller's web server may process HTTP commands selected from the following list, which includes a reference to the IETF RFC that details the methods:

RFC 2616

| | |
|---|---|
| OPTIONS | The OPTIONS method represents a request for information about the |
| | communication options available on the request/response chain identified by the |
| | Request-URI. This method allows the client to determine the options and/or |
| | requirements associated with a resource, or the capabilities of a server, without |
| | implying a resource action or initiating a resource retrieval. |
| GET | The GET method means retrieve whatever information (in the form of an entity) is |
| | identified by the Request-URI. If the Request-URI refers to a data-producing process, |
| | it is the produced data which shall be returned as the entity in the response and not |
| | the source text of the process, unless that text happens to be the output of the |
| | process. |
| HEAD | The HEAD method is identical to GET except that the server MUST NOT return a |
| | message-body in the response. The meta information contained in the HTTP headers |
| | in response to a HEAD request SHOULD be identical to the information sent in |
| | response to a GET request. This method can be used for obtaining meta information |
| | about the entity implied by the request without transferring the entity-body itself. |
| | This method is often used for testing hypertext links for validity, accessibility, and |
| | recent modification. |
| POST | The POST method is used to request that the origin server accept the entity enclosed |
| | in the request as a new subordinate of the resource identified by the Request-URI in |
| | the Request-Line. POST is designed to allow a uniform method to cover the following |
| | functions: |
| | Annotation of existing resources; |
| | Posting a message to a bulletin board, newsgroup, mailing list, or similar |
| | group of articles; |
| | Providing a block of data, such as the result of submitting a form, to a data- |
| | handling process; |
| | Extending a database through an append operation. |
| PUT | The PUT method requests that the enclosed entity be stored under the supplied |
| | Request-URI. If the Request-URI refers to an already existing resource, the enclosed |
| | entity SHOULD be considered as a modified version of the one residing on the origin |
| | server. If the Request-URI does not point to an existing resource, and that URI is |
| | capable of being defined as a new resource by the requesting user agent, the origin |
| | server can create the resource with that URI. If a new resource is created, the origin |
| | server MUST inform the user agent via the 201 (Created) response. If an existing |
| | resource is modified, either the 200 (OK) or 204 (No Content) response codes |
| | SHOULD be sent to indicate successful completion of the request. If the resource |
| | could not be created or modified with the Request-URI, an appropriate error |
| | response SHOULD be given that reflects the nature of the problem. The recipient of |
| | the entity MUST NOT ignore any Content-* (e.g. Content-Range) headers that it does |
| | not understand or implement and MUST return a 501 (Not Implemented) response |
| | in such cases. |
| DELETE | The DELETE method requests that the origin server delete the resource identified by |
| | the Request-URI. This method MAY be overridden by human intervention (or other |
| | means) on the origin server. The client cannot be guaranteed that the operation has |
| | been carried out, even if the status code returned from the origin server indicates |
| | that the action has been completed successfully. However, the server SHOULD NOT |
| | indicate success unless, at the time the response is given, it intends to delete the |
| | resource or move it to an inaccessible location. |
| TRACE | The TRACE method is used to invoke a remote, application-layer loop-back of the |
| | request message. The final recipient of the request SHOULD reflect the message |
| | received back to the client as the entity-body of a 200 (OK) response. The final |
| | recipient is either the origin server or the first proxy or gateway to receive a Max- |
| | Forwards value of zero (0) in the request (see section 14.31). A TRACE request MUST |
| | NOT include an entity. |
| CONNECT | This specification reserves the method name CONNECT for use with a proxy that can |
| | dynamically switch to being a tunnel |

RFC 2518

| | |
|---|---|
| PROPFIND | The PROPFIND method retrieves properties defined on the resource identified by |
| | the Request-URI, if the resource does not have any internal members, or on the |
| | resource identified by the Request-URI and potentially its member resources, if the |
| | resource is a collection that has internal member URIs. All DAV compliant |
| | resources MUST support the PROPFIND method and the PROPFIND XML element |
| PROPPATCH | The PROPPATCH method processes instructions specified in the request body to |
| | set and/or remove properties defined on the resource identified by the Request- |
| | URI. |
| MKCOL | The MKCOL method is used to create a new collection. All DAV compliant |
| | resources MUST support the MKCOL method. |
| COPY | The COPY method creates a duplicate of the source resource, identified by the |
| | Request-URI, in the destination resource, identified by the URI in the Destination |
| | header. The Destination header MUST be present. The exact behavior of the COPY |
| | method depends on the type of the source resource. |
| MOVE | The MOVE operation on a non-collection resource is the logical equivalent of a |
| | copy (COPY), followed by consistency maintenance processing, followed by a |
| | delete of the source, where all three actions are performed atomically. The |
| | consistency maintenance step allows the server to perform updates caused by the |
| | move, such as updating all URIs other than the Request-URI which identify the |
| | source resource, to point to the new destination resource. Consequently, the |
| | Destination header MUST be present on all MOVE methods and MUST follow all |
| | COPY requirements for the COPY part of the MOVE method. All DAV compliant |
| | resources MUST support the MOVE method. However, support for the MOVE |
| | method does not guarantee the ability to move a resource to a particular |
| | destination. |
| LOCK | The following sections describe the LOCK method, which is used to take out a lock |
| | of any access type. These sections on the LOCK method describe only those |
| | semantics that are specific to the LOCK method and are independent of the access |
| | type of the lock being requested. |
| UNLOCK | The UNLOCK method removes the lock identified by the lock token in the Lock- |
| | Token request header from the Request-URI, and all other resources included in |
| | the lock. If all resources which have been locked under the submitted lock token |
| | cannot be unlocked, then the UNLOCK request MUST fail. |

RFC 3253

| | |
|---|---|
| VERSION-CONTROL | A VERSION-CONTROL request can be used to create a version-controlled |
| | resource at the request-URL. It can be applied to a versionable resource or |
| | to a version-controlled resource. |
| REPORT | A REPORT request is an extensible mechanism for obtaining information |
| | about a resource. Unlike a resource property, which has a single value, the |
| | value of a report can depend on additional information specified in the |
| | REPORT request body and in the REPORT request headers. |
| CHECKOUT | A CHECKOUT request can be applied to a checked-in version-controlled |
| | resource to allow modifications to the content and dead properties of that |
| | version-controlled resource. |
| CHECKIN | A CHECKIN request can be applied to a checked-out version-controlled |
| | resource to produce a new version whose content and dead properties are |
| | copied from the checked-out resource. |
| UNCHECKOUT | An UNCHECKOUT request can be applied to a checked-out version- |
| | controlled resource to cancel the CHECKOUT and restore the pre- |
| | CHECKOUT state of the version-controlled resource. |
| MKWORKSPACE | An UNCHECKOUT request can be applied to a checked-out version- |
| | controlled resource to cancel the CHECKOUT and restore the pre- |
| | CHECKOUT state of the version-controlled resource. |
| UPDATE | The UPDATE method modifies the content and dead properties of a |
| | checked-in version-controlled resource (the “update target”) to be those |
| | of a specified version (the “update source”) from the version history of |
| | that version-controlled resource. |
| LABEL | A LABEL request can be applied to a version to modify the labels that |
| | select that version. The case of a label name MUST be preserved when it is |
| | stored and retrieved. When comparing two label names to decide if they |
| | match or not, a server SHOULD use a case-sensitive URL-escaped UTF-8 |
| | encoded comparison of the two label names. |
| MERGE | The MERGE method performs the logical merge of a specified version (the |
| | “merge source”) into a specified version-controlled resource (the “merge |
| | target”). If the merge source is neither an ancestor nor a descendant of |
| | the DAV: checked-in or DAV: checked-out version of the merge target, the |
| | MERGE checks out the merge target (if it is not already checked out) and |
| | adds the URL of the merge source to the DAV: merge-set of the merge |
| | target. It is then the client's responsibility to update the content and dead |
| | properties of the checked-out merge target so that it reflects the logical |
| | merge of the merge source into the current state of the merge target. The |
| | client indicates that it has completed the update of the merge target, by |
| | deleting the merge source URL from the DAV: merge-set of the checked- |
| | out merge target, and adding it to the DAV: predecessor-set. As an error |
| | check for a client forgetting to complete a merge, the server MUST fail an |
| | attempt to CHECKIN a version-controlled resource with a non-empty DAV: |
| | merge-set. |
| BASELINE-CONTROL | A collection can be placed under baseline control with a BASELINE- |
| | CONTROL request. When a collection is placed under baseline control, the |
| | DAV: version-controlled-configuration property of the collection is set to |
| | identify a new version-controlled configuration. This version-controlled |
| | configuration can be checked out and then checked in to create a new |
| | baseline for that collection. |
| MKACTIVITY | A MKACTIVITY request creates a new activity resource. A server MAY |
| | restrict activity creation to particular collections, but a client can |
| | determine the location of these collections from a DAV: activity-collection- |
| | set OPTIONS request. |

RFC 3648

| | |
|---|---|
| ORDERPATCH | The ORDERPATCH method is used to change the ordering semantics of a |
| | collection, to change the order of the collection's members in the ordering, or |
| | both. |

RFC 3744

| | |
|---|---|
| ACL | The ACL method modifies the access control list (which can be read via the DAV: acl |
| | property) of a resource. Specifically, the ACL method only permits modification to ACEs |
| | that are not inherited, and are not protected. An ACL method invocation modifies all non- |
| | inherited and non-protected ACEs in a resource's access control list to exactly match the |
| | ACEs contained within in the DAV: acl XML element (specified in Section 5.5) of the request |
| | body. |

In alternate embodiments, however, the remote management hardware and/or firmware microcontroller's web server is implemented to support a small number of HTTP methods that will allow a minimum number of desired management operations. Web server embodiments that support a small number of HTTP methods require fewer instructions and more easily fit into the ROM firmware space that is available to the remote management hardware and/or firmware microcontroller.

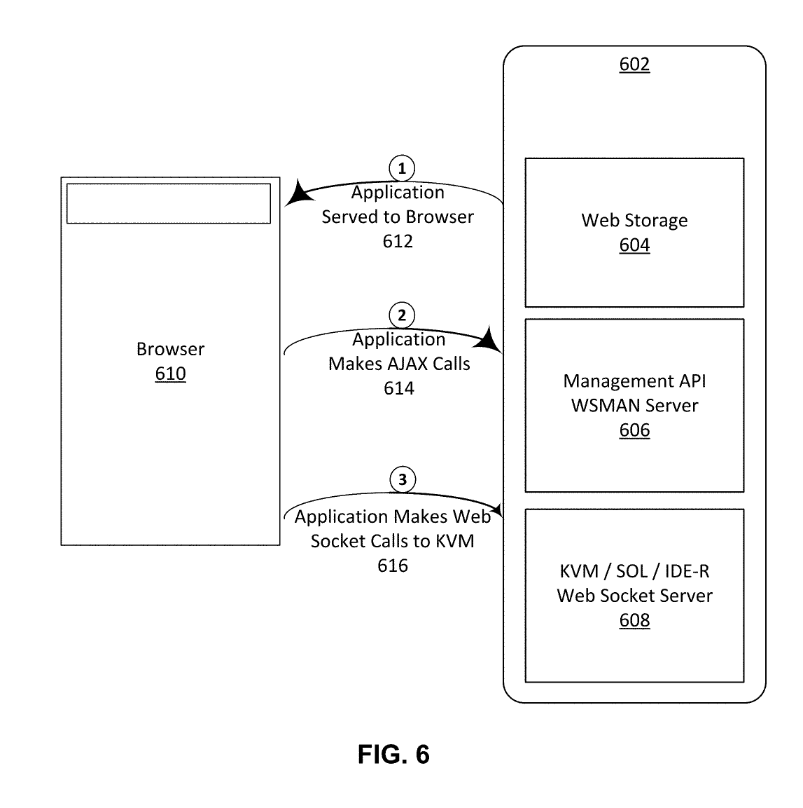

FIG. 6 is a block diagram illustrating an embodiment of a process to use a web application to establish a two-way connection with the remote management hardware and/or firmware. At 612, at a path labeled as “1,” an application is served by remote management hardware and/or firmware 602 from web storage 604 to a browser 610 running on a remote computer and operated by an administrator. In some embodiments, the application is stored ahead of time on a flash memory, as part of the firmware and shipped with it allowing a manufacturer to customize the application for different types of systems or customers. In some embodiments, remote management hardware and/or firmware is later used to update the application to a newer version. Browser 610 in the illustrated embodiment runs JavaScript code and, at the application running in the browser at 614 makes AJAX (Asynchronous Java and XML) calls back to the remote management hardware and/or firmware, over the path labeled as “2.” The AJAX calls are received by remote management hardware and/or firmware's management API WSMAN server 606. As used herein, WSMan server 606 provides methods for creating a session, and enables a socket to be established between Browser 610 and remote management hardware and/or firmware 602. Creating a socket allows a benefit of allowing a full-remote two-way connection between the browser 610 and remote management hardware and/or firmware 602. Having established a socket, the application at 616 makes web socket calls to KVM, over the path labeled as “3.” As used herein, KVM refers to a Keyboard Video Mouse which is a remote desktop solution that allows a remote management console to remotely manage a system using remote management hardware and/or firmware 602, even when the processor and its operating system are not functional. KVM allows remote manipulation of BIOS settings. In some embodiments, the implementation of web sockets in the remote management hardware and/or firmware 602 allows out-of-band management of the processor with a KVM session using a web browser on the remote computer with no additional software installed.

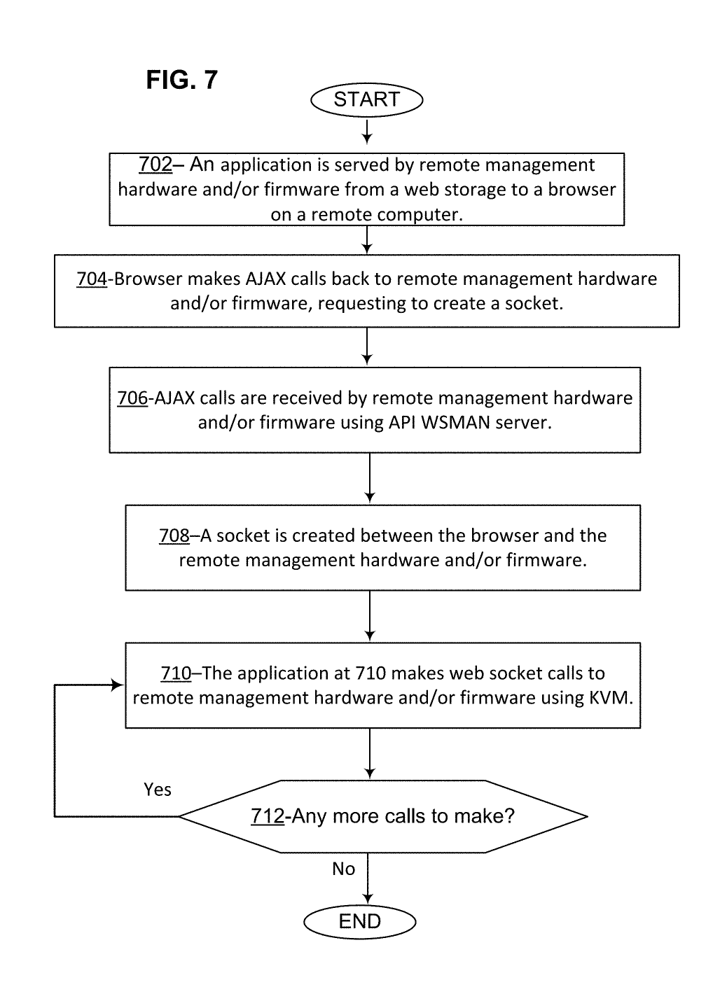

FIG. 7 is a flow diagram illustrating an embodiment of a process to use a web application to establish a two-way connection with remote management hardware and/or firmware. At 702, an application is served by remote management hardware and/or firmware from a web storage to a browser on a remote computer. At 704, the browser, which in this embodiment runs JavaScript code, makes AJAX calls back to the remote management hardware and/or firmware, requesting to create a socket. At 706, the AJAX calls are received by remote management hardware and/or firmware's management API WSMAN server. At 708, a socket is created between the browser and the remote management hardware and/or firmware. Creating a socket allows a benefit of allowing a full-remote two-way connection between the browser and the remote management hardware and/or firmware. Having established a socket, the application at 710 makes web socket calls to the remote management hardware and/or firmware's KVM. At 712, if there are any more calls to be made, the process returns to 710. Otherwise, the process ends.

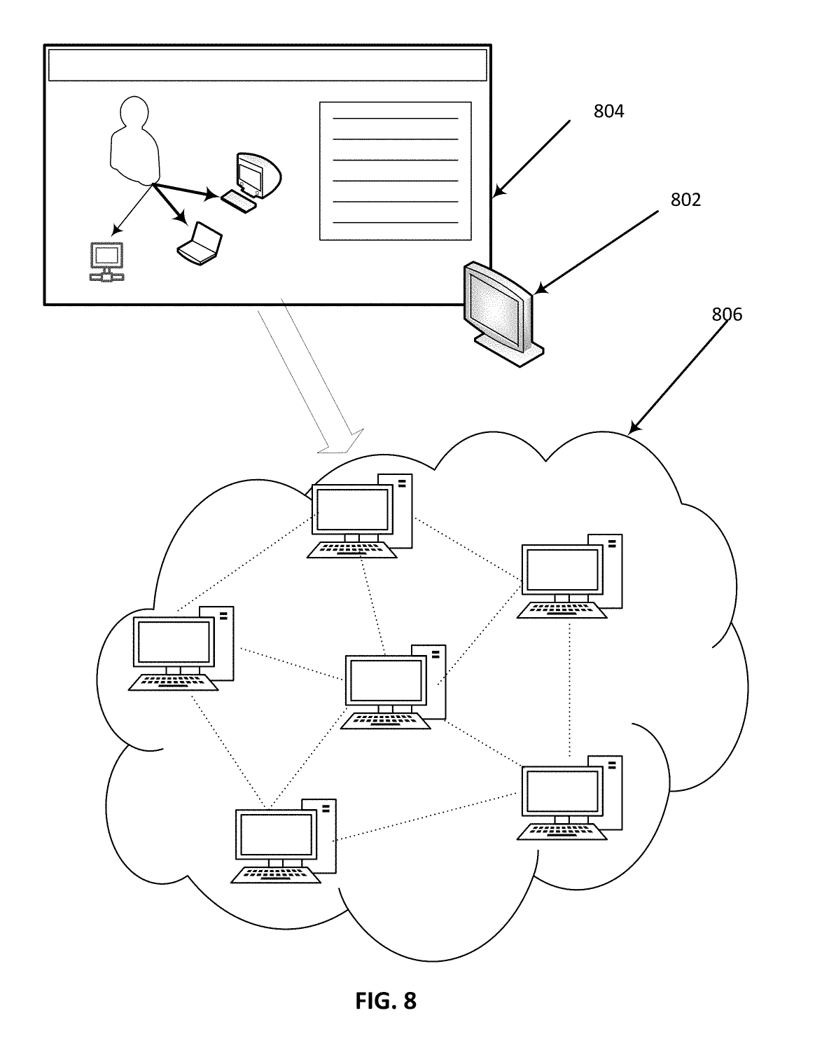

FIG. 8 is an embodiment of a process of using a web browser to remotely manage each computer in a cloud of computers. As shown, a remote computer 802, operated for example by an administrator, runs a web browser application to administer a cloud of computers, 806, each of the computers incorporating embodiments of remote management using remote management hardware and/or firmware, as disclosed herein. The administrator uses a browser to administer an unlimited number of computers in the cloud. Furthermore, in some embodiments, the computers in cloud 806 implement the remote management embodiments disclosed herein, and are therefore ready to use as soon as they are “out of the box.” The administrator uses the browser to perform management operations, and does not load or utilize any third party software.

Accordingly, some embodiments offer the benefit of an out-of-the-box experience, insofar as computers incorporating the enclosed embodiments are administered and managed out-of-the-box, using a web browser running on a remote computer. Enclosed embodiments allow computers to be updated, reconfigured, internationalized, and branded remotely using a web browser. Enclosed embodiments also enable a real-time, two-way socket to be established using a web browser on a remote computer.

### Examples

Example 1 provides a system, including a microcontroller to configure a processor, the microcontroller including a memory, a network interface coupled to the microcontroller, the network interface to send and receive communications with an external device, a non-volatile memory to store computer executable instructions to be executed by the microcontroller, and a power supply to provide power to the microcontroller, the network interface, and the non-volatile memory regardless of the power state of the processor. The microcontroller further to provide a web server to receive and process HyperterText Transfer Protocol (HTTP) requests from the external device.

Example 2 includes the subject matter of example 1. In this example, the HTTP requests are to instruct the microcontroller to configure the processor.

Example 3 includes the subject matter of example 1. In this example, the HTTP requests are to specify management operations to be performed by the microcontroller.

Example 4 includes the subject matter of example 1. In this example, the power state of the processor is sleep.

Example 5 includes the subject matter of example 1. In this example, the power state of the processor is soft-off.

Example 6 includes the subject matter of example 1. In this example, the power state of the processor is not active.

Example 7 includes the subject matter of example 1. In this example, the web server is to accept and to process a request to push content into the memory, and, in response to at least one request to get a web page, the web server is to dynamically generate a responsive web page reflecting the content stored in the memory.

Example 8 includes the subject matter of example 7. In this example, the microcontroller further includes a cache memory to store data for use in the dynamically generated responsive web page.

Example 9 includes the subject matter of example 1. In this example, the web server is to support a web socket bidirectional connection with the remote computer.

Example 10 includes the subject matter of example 1. In this example, the computer executable instructions are to fit within the amount of memory space contained in the non-volatile memory.

Example 11 is a system for remotely administering a processor. The system includes a microcontroller to configure the processor, the microcontroller including a memory, a network interface coupled to the microcontroller, the network interface to send and receive communications with an external device, a non-volatile memory to store computer executable instructions to be executed by the microcontroller, and means for providing power to the microcontroller, the network interface, and the non-volatile memory to allow them to operate regardless of the power state of the processor. The microcontroller in this example is to provide a web server to receive and process HyperterText Transfer Protocol (HTTP) requests from the external device.

Example 12 includes the subject matter of example 11. In this example, the HTTP requests are to instruct the microcontroller to configure the processor.

Example 13 includes the subject matter of any one of examples 11 to 12. In this example, the HTTP requests are to specify management operations to be performed by the microcontroller.

Example 14 includes the subject matter of any one of examples 11 to 13. In this example, the power state of the processor is sleep.

Example 15 includes the subject matter of any one of examples 11 to 13. In this example, the power state of the processor is soft-off.

Example 16 includes the subject matter of any one of examples 11 to 13. In this example, the power state of the processor is not active.

Example 17 includes the subject matter of any one of examples 11 to 16. In this example, the web server is to accept and to process a request to push content into the memory, and, in response to at least one request to get a web page, the web server is to dynamically generate a responsive web page reflecting the content stored in the memory.

Example 18 includes the subject matter of example 17. In this example, the microcontroller is further to include a cache memory to store data for use in the dynamically generated responsive web page.

Example 19 includes the subject matter of any one of examples 11 to 18. In this example, the web server is to support a web socket bidirectional connection with the remote computer.

Example 20 includes the subject matter of any one of examples 11 to 19. In this example, the computer executable instructions are to fit within the amount of memory space contained in the non-volatile memory.

Example 21 is a method for remotely managing a processor. The method includes providing sufficient power to a microcontroller, a network interface, and a flash memory to allow them to operate regardless of the power state of the processor, using instructions read from a non-volatile memory by the microcontroller to implement a web server to receive and process HTTP requests from a remote computer.

Example 22 includes the subject matter of example 21. In this example, the HTTP requests are to instruct the microcontroller to configure the processor.

Example 23 includes the subject matter of any one of examples 21 to 22. In this example, the HTTP requests are to specify management operations to be performed by the microcontroller.

Example 24 includes the subject matter of any one of examples 21 to 23. In this example, the power state of the processor is sleep.

Example 25 includes the subject matter of any one of examples 21 to 23. In this example, the power state of the processor is soft-off.

Example 26 includes the subject matter of any one of examples 21 to 25. In this example, the web server is to accept and to process a request to push content into the memory, and, in response to at least one request to get a web page, the web server is to dynamically generate a responsive web page reflecting the content stored in the memory.

Example 27 includes the subject matter of any one of examples 21 to 26. In this example, the computer executable instructions are to fit within the amount of memory space contained in the non-volatile memory.

Example 28 provides a non-transitory computer-readable medium containing computer executable instructions that, when executed by a microcontroller including a memory, the microcontroller coupled to a processor, a network interface, a non-volatile memory, and a power supply, wherein the power supply is to provide sufficient power to the microcontroller, the network interface, and the non-volatile memory to allow the microcontroller to operate regardless of the power state of the processor, to perform a process of: reading computer-executable instructions from the non-volatile memory, and executing the instructions to provide a web server to receive and process HTTP requests from an external device.

Example 29 includes the subject matter of example 28. In this example, the power state of the processor is sleep.

Example 30 includes the subject matter of example 28. In this example, the power state of the processor is soft-off.

Example 31 is a method for remotely configuring a processor. The method includes steps for providing sufficient power to a microcontroller, a network interface, and a flash memory to allow them to operate when the power state of the processor is at least one of sleeping and soft-off, and using instructions read from a flash memory by the microcontroller to implement a web server to receive and process HTTP requests from a remote computer.

Example 32 includes the subject matter of example 31. In this example, the HTTP requests are to instruct the microcontroller to configure the processor.

Example 33 includes the subject matter of any one of examples 31 to 32. In this example, the HTTP requests are to specify management operations to be performed by the microcontroller.

Example 34 includes the subject matter of any one of examples 31 to 33. In this example, the web server is to accept and to process a request to push content into the memory, and, in response to at least one request to get a web page, the web server is to dynamically generate a responsive web page reflecting the content stored in the memory.

Example 35 includes the subject matter of any one of examples 31 to 34. In this example, the computer executable instructions are to fit within the amount of memory space contained in the flash memory.

The above examples include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

In the foregoing specification, specific exemplary embodiments have been disclosed. It will, however, be evident that various modifications and changes may be made thereto without departing from the broader spirit and scope of the invention as set forth in the appended claims. The specification and drawings are, accordingly, to be regarded in an illustrative rather than a restrictive sense.

Although some embodiments disclosed herein involve data handling and distribution in the context of hardware execution units and logic circuits, other embodiments can be accomplished by way of a data or instructions stored on a non-transitory machine-readable, tangible medium, which, when performed by a machine, cause the machine to perform functions consistent with at least one embodiment. In one embodiment, functions associated with embodiments of the present disclosure are embodied in machine-executable instructions. The instructions can be used to cause a general-purpose or special-purpose processor that is programmed with the instructions to perform the steps of the at least one embodiment. Embodiments of the present invention may be provided as a computer program product or software which may include a machine or computer-readable medium having stored thereon instructions which may be used to program a computer (or other electronic devices) to perform one or more operations according to the at least one embodiment. Alternatively, steps of embodiments may be performed by specific hardware components that contain fixed-function logic for performing the steps, or by any combination of programmed computer components and fixed-function hardware components.

Instructions used to program logic to perform the at least one embodiment can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

What is claimed is:

1. A system comprising:
a microcontroller to configure a processor, the microcontroller comprising a memory;
a network interface coupled to the microcontroller, the network interface to send and receive communications with an external device;
a non-volatile memory to store computer executable instructions to be executed by the microcontroller;
a power supply to provide power to the microcontroller, the network interface, and the non-volatile memory regardless of the power state of the processor; and
the microcontroller further to provide a web server to receive and process HyperterText Transfer Protocol (HTTP) requests from the external device.

2. The system of claim 1, wherein the HTTP requests are to instruct the microcontroller to configure the processor.

3. The system of claim 1, wherein the HTTP requests are to specify management operations to be performed by the microcontroller.

4. The system of claim 1, wherein the power state of the processor is sleep.

5. The system of claim 1, wherein the power state of the processor is soft-off.

6. The system of claim 1, herein the power state of the processor is at least one of C1, C2, and C3.

7. The system of claim 1, wherein the web server to accept and to process a request to push content into the memory, and wherein, in response to at least one request to get a web page, the web server to dynamically generate a responsive web page reflecting the content stored in the memory.

8. The system of claim 7, the microcontroller further comprising a cache memory to store data for use in the dynamically generated responsive web page.

9. The system of claim 1, wherein the web server to support a web socket bidirectional connection with the remote computer.

10. The system of claim 1, wherein the computer executable instructions to fit within the amount of memory space contained in the non-volatile memory.

11. A method comprising:
providing sufficient power to a microcontroller, a network interface, and a flash memory to allow the microcontroller to operate regardless of the power state of a processor;
using instructions read from a flash memory by the microcontroller to implement a web server to receive and process HTTP requests from a remote computer.

12. The method of claim 11, wherein the HTTP requests to instruct the microcontroller to configure the processor.

13. The method of claim 11, wherein the HTTP requests to specify management operations to be performed by the microcontroller.

14. The method of claim 11, wherein the power state of the processor is sleep.

15. The method of claim 11, wherein the power state of the processor is soft-off.

16. The method of claim 11, wherein the web server to accept and to process a request to push content into the memory, to associate the content with a uniform record locator (URL), and in response to at least one request to get a web page from the URL, to dynamically generate a responsive web page reflecting the content stored in the memory.

17. The method of claim 11, wherein the computer executable instructions fit within the amount of memory space contained in the non-volatile memory.

18. A non-transitory computer-readable medium containing computer executable instructions that, when executed by a microcontroller comprising a memory, the microcontroller coupled to a processor, a network interface, a non-volatile memory, and a power supply, wherein the power supply to provide sufficient power to the microcontroller, the network interface, and the non-volatile memory to allow the microcontroller to operate regardless of the power state of the processor, the microcontroller to perform a process of:
reading computer-executable instructions from the non-volatile memory; and
executing the instructions to provide a web server to receive and process HTTP requests from an external device.

19. The non-transitory computer-readable medium of claim 18, wherein the power state is sleep.

20. The non-transitory computer-readable medium of claim 18, wherein the power state is soft-off.
